(19) United States
(12) Patent Application Publication
(10) Pub. No.: US 2002/0067545 A1
(43) Pub. Date: Jun. 6, 2002

(54) Twin-lens type projection display

(75) Inventor: Fu-Ming Chuang, Hsin-Chu Hsien (TW)

Correspondence Address: WEBB ZIESENHEIM LOGSDON, ORKIN & HANSON, P.C., 700 Koppers Building, 436 Seventh Avenue, Pittsburgh, PA, 15219-1818, US

(73) Assignee: PROKIA TECHNOLOGY CO., LTD.

(21) Appl. No.: 09/731,377

(22) Filed: Dec. 5, 2000

(51) Int. Cl. G03B 21/26; G02B 5/30; G02B 27/28

(52) U.S. Cl. 359/483; 359/485; 353/20; 353/34

(57) ABSTRACT

In a projection display, a dichroic beam splitter separates white light into a first color set that includes first and second color components, and a second color set that includes a third color component, such that the first color set traverses an optical path different from that of the second color set. A first light polarization selector receives the first color set from the dichroic beam splitter, and a first polarized beam splitter prism receives the first color set from the first light polarization selector. The first polarized beam splitter prism directs the color components in the first color set to first and second light modulators respectively for light modulation. The first and second light modulators reflect the light-modulated color components of the first color set back to the first polarized beam splitter prism for reception by a second light polarization selector and a first projection lens. A second polarized beam splitter prism receives the second color set from the dichroic beam splitter, and directs the second color set to a third light modulator for light modulation. The third light modulator reflects the light-modulated second color set back to the second polarized beam splitter prism for reception by a second projection lens.

### BACKGROUND OF THE INVENTION

1. Field of the Invention

The invention relates to a projection display, more particularly to a twin-lens type projection display.

2. Description of the Related Art

A conventional single-lens type projection display that incorporates a color separation/recombination prism unit formed from four right-angle prisms has the following drawbacks:

1. The four right-angle prisms have to be manufactured with a relatively high degree of precision to ensure that three color components (such as red, blue and green color components) of the color image can be properly combined, thereby resulting in a corresponding increase in the difficulty of manufacturing the color separation/recombination prism unit.

2. Currently, cementing planes among the four right-angle prisms should be no thicker than 5 microns to minimize the occurrence of image distortion. However, in the event of an eventual improvement in the resolution of color component modulators, such as liquid crystal light valves, due to ongoing advancement in the relevant technology, the presence of the cementing planes will undesirably generate an adverse effect on the projected image.

3. The color separation/recombination prism unit is unable to allow full reflection or transmission of the different color components, thereby arising in cross-talk. In other words, if any one of the color components is only partly reflected or transmitted by the color separation/recombination prism unit, the non-reflected or non-transmitted portion will be undesirably received by the color component modulators for the other two color components.

4. There is a long back focal distance due to the arrangement of the color component modulators and the color separation/recombination prism unit.

FIG. 1 illustrates another conventional single-lens type projection display 1 that does not incorporate a color separation/recombination prism unit. As illustrated, the projection display 1 includes a first light polarization selector 111, a second light polarization selector 112, a polarized beam splitter prism 12, a dichroic beam splitter prism 13, a first light modulator 141, a second light modulator 142, a third light modulator 143, a polarizer 15, and a projection lens 16. S-polarized white light 10 includes first, second and third color components 101, 102, 103 (such as red, blue and green color components) that are to be modulated by the first, second and third light modulators 141, 142, 143, respectively.

The first and second light polarization selectors 111, 112, such as the ColorSelect™ filter products available from ColorLink Inc., serve to convert the polarization state of a predetermined color component. In the projection display 1 of FIG. 1, the polarization state of the third color component 103 is changed from S-polarization state into P-polarization state after passing through the first light polarization selector 111.

The polarization beam splitter prism 12 permits the P-polarized third color component 103 to pass therethrough, and reflects the S-polarized first and second color components 101, 102.

The dichroic beam splitter prism 13 receives the first and second color components 101, 102 from the polarization beam splitter prism 12. The first color component 101 passes directly through the dichroic beam splitter prism 13, whereas the second color component 102 is reflected by the dichroic beam splitter prism 13.

The first and second light modulators 141, 142 modulate the first and second color components 101, 102 from the dichroic beam splitter prism 13, change the polarization state of the corresponding color component from S-polarization state into P-polarization state when the first and second light modulators 141, 142 are activated, and reflect the corresponding color component back to the dichroic beam splitter prism 13. The P-polarized first and second color components 101, 102 reflected from the first and second light modulators 141, 142 pass through the dichroic beam splitter prism 13, the polarization beam splitter prism 12, and the second light polarization selector 112 before reaching the polarizer 15.

The third light modulator 143 modulates the third color component 103 from the polarization beam splitter prism 12, changes the polarization state of the third color component 103 from P-polarization state into S-polarization state when the third light modulator 143 is activated, and reflects the third color component 103 back to the polarization beam splitter prism 12. The S-polarized third color component 103 from the third light modulator 143 is reflected by the polarization beam splitter prism 12 to pass through the second light polarization selector 112, thereby changing the polarization state of the third color component 103 back into P-polarization state, before the third color component 103 reaches the polarizer 15.

The polarizer 15 permits only pure P-polarized color components to pass therethrough. The first, second and third color components 101, 102, 103 from the polarizer 15 are recombined as they pass through the projection lens 16 for projecting a color image on a display screen (not shown).

It is noted that the problem of a long back focal distance is not resolved in the conventional projection display 1 of FIG. 1. In addition, the transmission spectrum of the dichroic beam splitter prism 13 is different between the P-polarization and S-polarization states. A shift in spectrum frequency is thus introduced to the first color component 101 (i.e. the red color component) as well as the second color component 102 (i.e. the blue color component), which can affect adversely the image quality. Furthermore, as is well known in the art, the polarization beam splitter prism 12 is unable to allow a very large portion of the P-polarized third color component 103 to pass therethrough due to manufacturing constraints of the polarization beam splitter prism 12. Thus, portions of the third color component 103 will be undesirably reflected to the first and second light modulators 141, 142, which leads to a reduction in image contrast.

### SUMMARY OF THE INVENTION

Therefore, the object of the present invention is to provide a twin-lens type projection display that dispenses with the use of a color separation/recombination prism unit (composed of four right-angle prisms) and a dichroic beam splitter prism (which causes spectrum shift) and that is capable of overcoming the aforesaid drawbacks of the conventional single-lens type projection displays.

Accordingly, the projection display of this invention comprises a dichroic beam splitter, a first light polarization selector, a first polarized beam splitter prism, a first light modulator, a second light modulator, a second light polarization selector, a second polarized beam splitter prism, a third light modulator, and first and second projection lenses. The dichroic beam splitter is adapted to separate white light of a first polarization state into a first color set that includes first and second color components, and a second color set that includes a third color component, such that the first color set traverses an optical path different from that of the second color set. The first light polarization selector receives the first color set from the dichroic beam splitter, and changes the polarization state of the first color component of the first color set into a second polarization state. The first polarized beam splitter prism receives the first color set from the first light polarization selector. The first light modulator is disposed adjacent to a first surface of the first polarized beam splitter prism, whereas the second light modulator is disposed adjacent to a second surface of the first polarized beam splitter prism. The first polarized beam splitter prism directs the first and second color components in the first color set to the first and second light modulators respectively for light modulation. The first and second light modulators reflect the light-modulated first and second color components of the first color set back to the first polarized beam splitter prism, and change the polarization states of the light-modulated first and second color components of the first color set into the first and second polarization states, respectively. The second light polarization selector receives the light-modulated first and second color components of the first color set from the first polarized beam splitter prism, and changes the polarization state of the first color component of the first color set back into the second polarization state. The second polarized beam splitter prism receives the second color set from the dichroic beam splitter. The third light modulator is disposed adjacent to the second polarized beam splitter prism. The second polarized beam splitter prism directs the second color set to the third light modulator for light modulation. The third light modulator reflects the light-modulated second color set back to the second polarized beam splitter prism, and changes the polarization state of the light-modulated second color set into the second polarization state. The first projection lens receives the first color set from the second light polarization selector. The second projection lens receives the second color set from the second polarized beam splitter prism.

### BRIEF DESCRIPTION OF THE DRAWINGS

Other features and advantages of the present invention will become apparent in the following detailed description of the preferred embodiment with reference to the accompanying drawings, of which:

FIG. 1 illustrates a conventional single-lens type projection display;

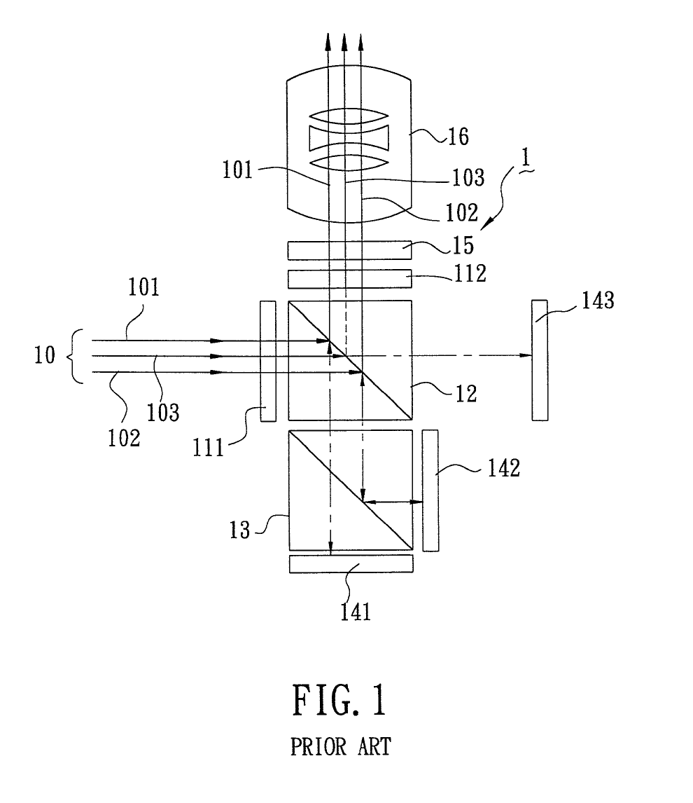

FIG. 2 is a perspective view showing the preferred embodiment of a twin-lens type projection display according to this invention;

FIG. 3 is a fragmentary schematic view illustrating how first and second color components are processed in the preferred embodiment; and

FIG. 4 is a fragmentary schematic view illustrating how a third color component is processed in the preferred embodiment.

### DETAILED DESCRIPTION OF THE PREFERRED EMBODIMENT

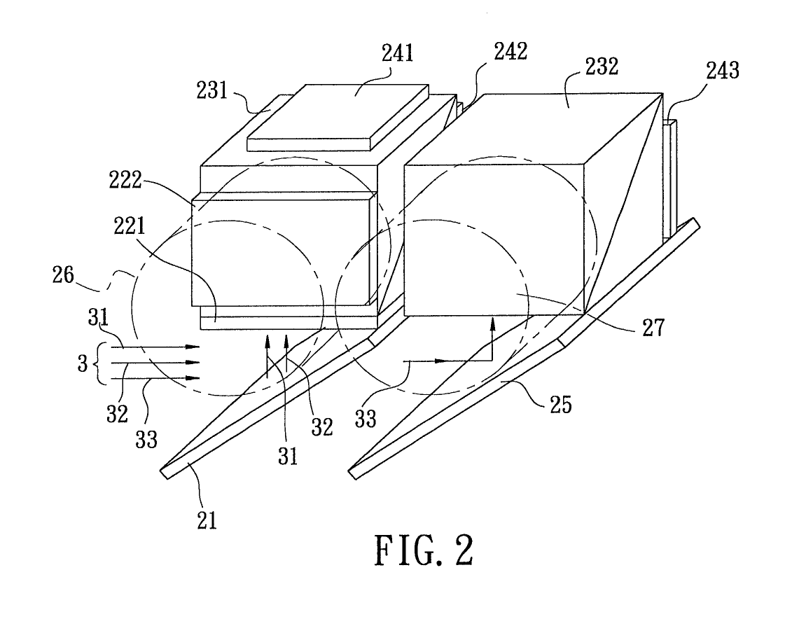

Referring to FIG. 2, the preferred embodiment of a twin-lens type projection display according to this invention is shown to comprise a dichroic beam splitting lens 21, a first light polarization selector 221, a second light polarization selector 222, a first polarized beam splitter prism 231, a second polarized beam splitter prism 232, a first light modulator 241, a second light modulator 242, a third light modulator 243, a mirror 25, and first and second projection lenses 26, 27 that are disposed adjacent to each other on a common horizontal plane and that have parallel optical axes. S-polarized white light 3 includes first, second and third color components 31, 32, 33 (such as red, blue and green color components) that are to be modulated by the first, second and third light modulators 241, 242, 243, respectively.

The dichroic beam splitting lens 21 separates the white light 3 into a first color set that includes the first and second color components 31, 32 (such as the red and blue color components), and a second color set that includes the third color component 33 (such as the green color component). The dichroic beam splitting lens 21 reflects the first color set, and allows the second color set to pass therethrough. Thus, the first and second color sets traverse different optical paths that are transverse to each other.

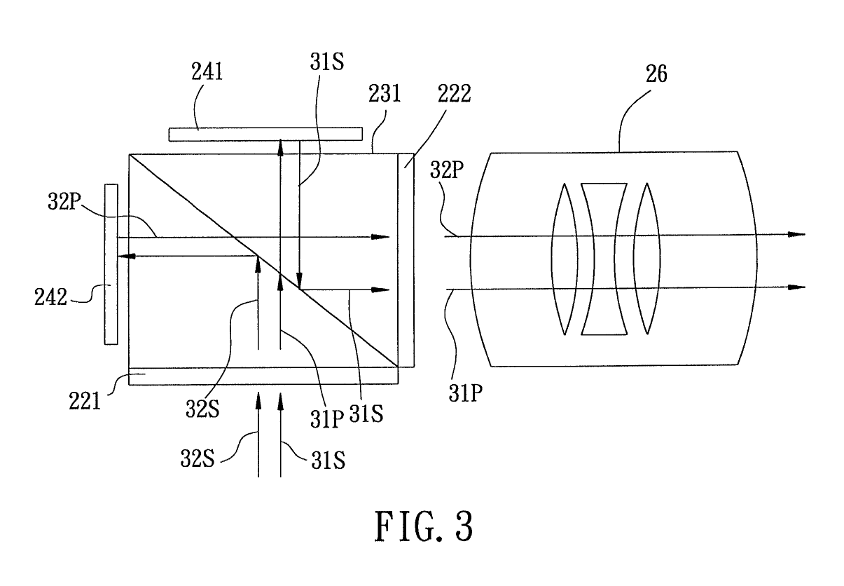

The first and second light polarization selectors 221, 222, such as the ColorSelect™ filter products available from ColorLink Inc., serve to convert the polarization state of a predetermined color component. With further reference to FIG. 3, the S-polarized first and second color components 31S, 32S are received by the first light polarization selector 221 from the dichroic beam splitting lens 21. The first color component is changed from S-polarization 31S into P-polarization 31P after passing through the first light polarization selector 221.

The first polarized beam splitter prism 231 receives the first color set from the first light polarization selector 221, permits the P-polarized first color component 31P to pass through a first surface thereof, and reflects the S-polarized second color component 32S such that the latter passes through a second surface of the first polarized beam splitter prism 231.

The first light modulator 241, such as a known reflective light valve, is disposed adjacent to the first surface of the first polarized beam splitter prism 231, modulates the P-polarized first color component 31P, changes the polarization state of the P-polarized first color component 31P, and reflects the light-modulated S-polarized first color component 31S back to the first polarized beam splitter prism 231.

The second light modulator 242, such as a known reflective light valve, is disposed adjacent to the second surface of the first polarized beam splitter prism 231, modulates the S-polarized second color component 32S, changes the polarization state of the S-polarized second color component 32S, and reflects the light-modulated P-polarized second color component 32P back to the first polarized beam splitter prism 231.

The second light polarization selector 222 receives the light-modulated S-polarized first color component 31S and the light-modulated P-polarized second color component 32P from the first polarized beam splitter prism 231. The first color component is changed from S-polarization 31S back into P-polarization 31P after passing through the second light polarization selector 222.

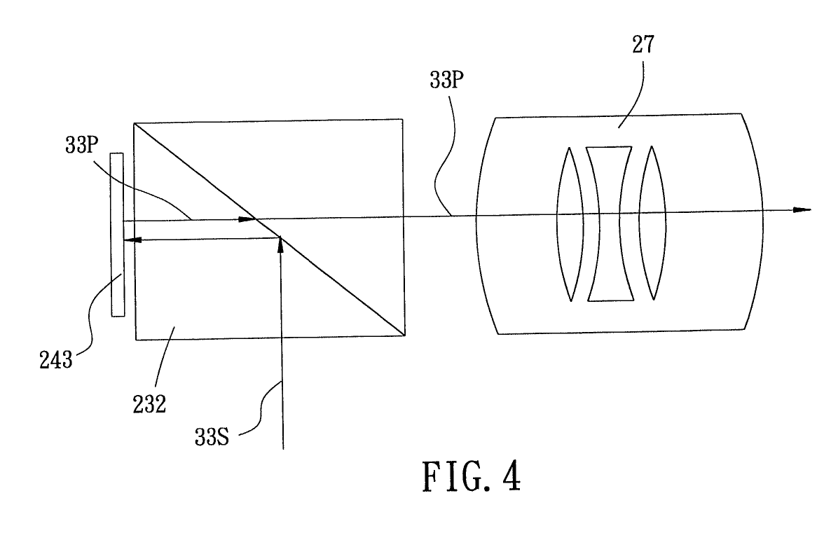

With reference to FIGS. 2 and 4, the second polarized beam splitter prism 232 receives the S-polarized third color component 33S from the dichroic beam splitting lens 21 via the mirror 25, and reflects the S-polarized third color component 33S. The third light modulator 243, such as a known reflective light valve, is disposed adjacent to the second polarized beam splitter prism 232 so as to receive the S-polarized third color component 33S therefrom, modulates the S-polarized third color component 33S, changes the polarization state of the S-polarized third color component 33S, and reflects the light-modulated P-polarized third color component 33P back to the second polarized beam splitter prism 232. The second polarized beam splitter prism 232 permits the light-modulated P-polarized third color component 33P to pass therethrough.

The first projection lens 26 receives the light-modulated P-polarized first color component 31P and the light-modulated P-polarized second color component 32P from the second light polarization selector 222. The second projection lens 27 receives the light-modulated P-polarized third color component 33P from the second polarized beam splitter prism 232. The first and second projection lenses 26, 27 cooperate to project a color image on a display screen (not shown).

By adjusting the relative positions of the second projection lens 27 and the third light modulator 243, the images projected by the first and second projection lenses 26, 27 can be made to overlap properly for forming a complete color image on the display screen.

In addition, since the projection display of this invention does not utilize a color separation/recombination prism unit (composed of four right-angle prisms) or a dichroic beam splitter prism, the projection display involves a less complicated manufacturing process, can avoid an undesired shift in the transmission spectrums of the different color components, and can minimize the occurrence of cross-talk.

Preferably, a quarter-wavelength plate (not shown) is disposed between the first light modulator 241 and the first polarized beam splitter prism 231, between the second light modulator 242 and the first polarized beam splitter prism 231, and between the third light modulator 243 and the second polarized beam splitter prism 232. Moreover, a polarizer (not shown) can be disposed between the second light polarization selector 222 and the first projection lens 26 and between the second polarized beam splitter prism 232 and the second projection lens 27, thereby achieving higher contrast among the color components.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

I claim:

1. A projection display comprising:
a dichroic beam splitter adapted to separate white light of a first polarization state into a first color set that includes first and second color components, and a second color set that includes a third color component, such that the first color set traverses an optical path different from that of the second color set;
a first light polarization selector for receiving the first color set from said dichroic beam splitter, said first light polarization selector changing the polarization state of the first color component of the first color set into a second polarization state;
a first polarized beam splitter prism for receiving the first color set from said first light polarization selector;
a first light modulator disposed adjacent to a first surface of said first polarized beam splitter prism;
a second light modulator disposed adjacent to a second surface of said first polarized beam splitter prism;
said first polarized beam splitter prism directing the first and second color components in the first color set to said first and second light modulators respectively for light modulation;
said first and second light modulators reflecting the light-modulated first and second color components of the first color set back to said first polarized beam splitter prism, and changing the polarization state of the light-modulated first and second color components of the first color set into the first and second polarization states, respectively;
a second light polarization selector for receiving the light-modulated first and second color components of the first color set from said first polarized beam splitter prism, said second light polarization selector changing the polarization state of the first color component of the first color set back into the second polarization state;
a second polarized beam splitter prism for receiving the second color set from said dichroic beam splitter;
a third light modulator disposed adjacent to said second polarized beam splitter prism;
said second polarized beam splitter prism directing the second color set to said third light modulator for light modulation;
said third light modulator reflecting the light-modulated second color set back to said second polarized beam splitter prism, and changing the polarization state of the light-modulated second color set into the second polarization state;
a first projection lens for receiving the first color set from said second light polarization selector; and
a second projection lens for receiving the second color set from said second polarized beam splitter prism.

2. The projection display of claim 1, wherein said first and second projection lenses are disposed adjacent to each other on a common horizontal plane and have parallel optical axes.

3. The projection display of claim 1, wherein said dichroic beam splitter is adapted to allow the second color set to pass therethrough, and is adapted to reflect the first color set for reception by said first light polarization selector.

4. The projection display of claim 3, further comprising a mirror for directing the second color set from said dichroic beam splitter to said second polarized beam splitter prism.
